(19) United States
(12) Patent Application Publication
(10) Pub. No.: US 2018/0074933 A1
(43) Pub. Date: Mar. 15, 2018

(54) MANAGEMENT OF LOG DATA IN ELECTRONIC SYSTEMS

(71) Applicant: ARM LIMITED, Cambridge (GB)

(72) Inventors: John Eugene NEYSTADT, Kfar-Saba (IL); Ethan POGREBIZSKY, Tel Aviv (IL); Erez LANDAU, Netanya (IL)

(21) Appl. No.: 15/689,409

(22) Filed: Aug. 29, 2017

(30) Foreign Application Priority Data
Sep. 13, 2016 (GB) 1615528.5

(51) Int. Cl. G06F 11/34; G06F 11/14; G06F 11/22; G06F 11/36; G06F 11/07

(52) U.S. Cl. CPC G06F 11/3476; G06F 11/14; G06F 11/2205; G06F 11/349; G06F 11/0745; G06F 11/0772; G06F 11/2268; G06F 11/3636

(57) ABSTRACT

The disclosed method comprises receiving operating environment data, such as resource availability data, from connected computing devices and services, analysing the data to create one or more policies governing log data storage and upload parameters, and sending the policies to the connected devices to enable them to limit resource consumption in the management of log data.

The present technology relates to methods and apparatus for operating electronic systems to manage log data, particularly for networks of connected computing devices and associated network-connected services. Such associated network-connected services may comprise software components running on one or more hardware devices.

Engineers often need to troubleshoot malfunctioning, malevolently interfered-with or erroneously misconfigured computing devices in a network, and to perform many other debugging activities (software- or hardware-related). Typical operations include retrieving logs from the device, which requires electronic connectivity, such as a direct connection like a Universal Serial Bus cable or a network connection; retrieving logs from a network-connected service that computing devices communicate with; and then manually searching for matching log entries to diagnose the problem. The computing devices and the service may be limited by software and hardware or software operating costs, such as shortages of required resources like power memory space and communications availability, which can cause performance problems and excessive memory consumption for storing logs. After they have been collected, the log entries must then be correlated with corresponding log entries from other devices and services by an administrator or system programmer, typically based on matching up internet protocol IP addresses, task identifiers, timestamps or similar parameters. Such correlation is manual, slow and especially difficult in the case of multiple devices connected via a network address translation (NAT) device, or where devices perform multiple transactions at the same time.

In a first approach to the many difficulties encountered in logging, the described technology provides a machine-implemented method of operating a network-connected service comprising: establishing communication with a network-connected computing device; acquiring, by the network-connected service from the network-connected computing device at least one indication of availability to the network-connected computing device of at least one resource; acquiring, by the network-connected service at least one indication of availability to the network-connected service of at least one resource; analysing a plurality of the indications to determine at least one of an optimal time and an optimal communication configuration for transmission of log data from the network-connected computing device to the network-connected service, where the optimal time and the optimal communication configuration are determined by resource availability to at least one of the network-connected computing device and the network-connected service; and sending, to the network-connected computing device, log transmission policy data to enable the network-connected computing device to select at least one of a transmission time and a communication configuration for transmission of the log data network-connected service in compliance with the policy data.

Implementations of the disclosed technology will now be described, by way of example only, with reference to the accompanying drawings, in which:

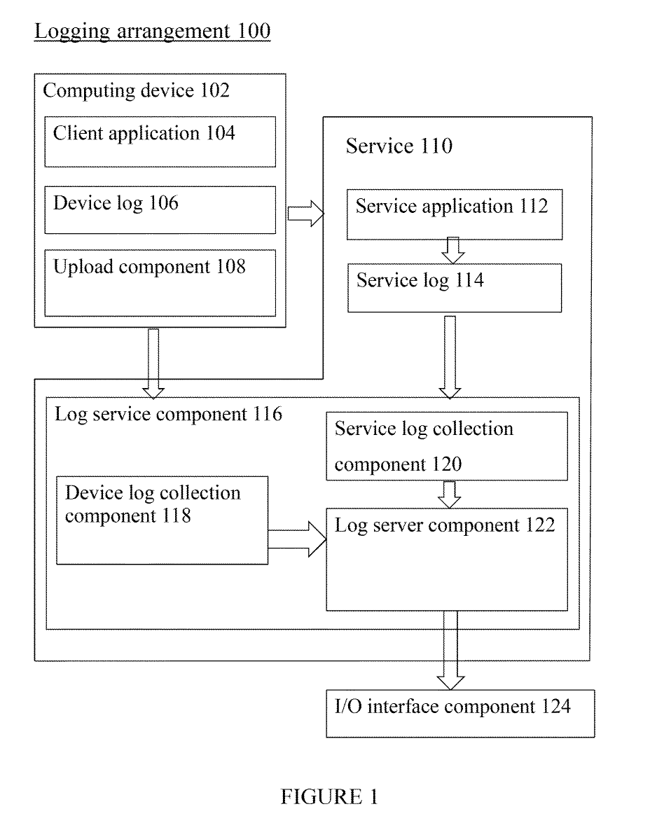

FIG. 1 shows a logging arrangement within which the presently described technology may be implemented;

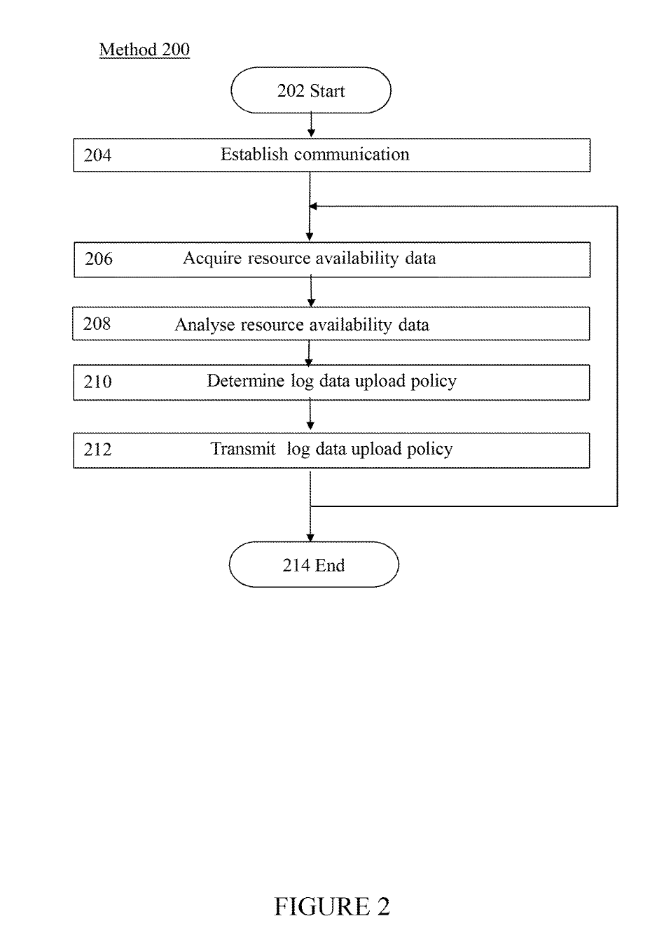

FIG. 2 shows an example of a method of operation according to the presently described technology; and

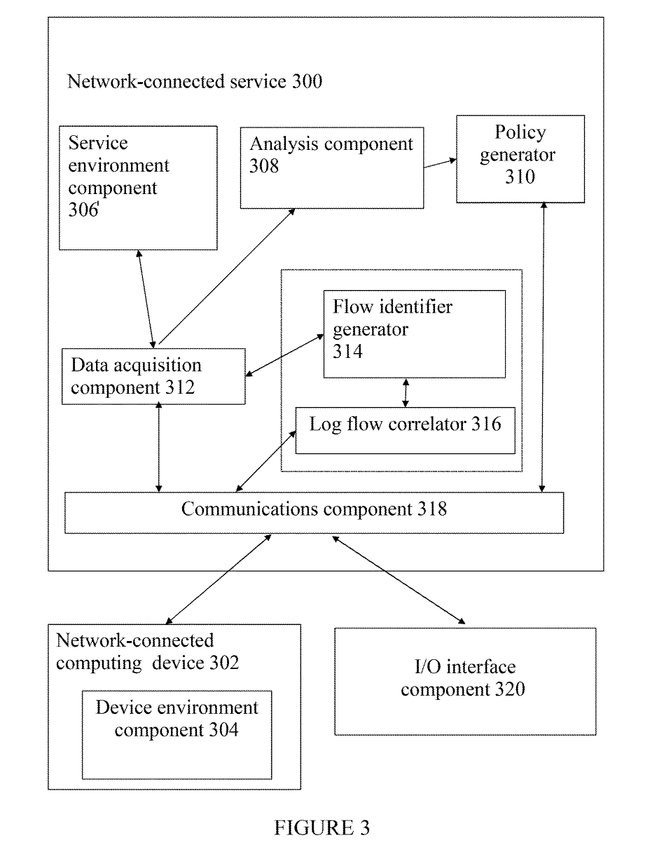

FIG. 3 shows an example of an electronic device operable according to the presently described technology.

In FIG. 1, there is shown a logging arrangement 100 within which the presently described technology may be implemented. Logging arrangement 100 comprises one or more computing devices 102 operatively connected to one or more services 110. Service 110 may comprise, for example, one or more software components running on single server computers, one or more software components running on a network of server computers, or one or more software components running on virtualised devices arranged in a network, such as, for example, a grid or cloud computing arrangement. Computing devices 102 may include, for example, Internet of Things (IoT) devices, such as networked sensors, consumer devices, intelligent home systems, automotive systems or the like, which may have intermittent network connectivity or power supply availability (being typically battery-powered, they may suffer from reduced battery charge levels at times). Computing device 102 comprises, typically, one or more client applications 104, which generate device logs 106, and, as such devices are typically resource-constrained (in memory space, processing power, power availability and communications connectivity, for example) they cannot themselves perform complex analyses of log data, and thus the log data needs to be limited in size and to be uploaded to a typically less-constrained service for analysis. Further, computing devices 102 are typically constrained in memory space or attached storage available for the storage of logs, and thus need to clear log data at frequent intervals, in order not to impact their performance and the availability of up-to-date log information when it is needed. Computing devices 102 are thus equipped with upload component 108, operable to upload the log data to one or more services 110. Service 110 typically performs transactions or tasks in conjunction with computing devices 102, and is provided with service applications 112, which themselves generate service log data stored in service log 114. Service 110 is equipped with log service component 116, which comprises a device log collection component 118 and a service log collection component 120. Log server component 122 may be provided with the means to make available the service logs 114 and the device logs 106 via I/O interface component 124.

In FIG. 2 is shown machine-implemented method 200, which commences at Start step 202. At step 204, communication is established between the service 110 of FIG. 1 and one or more computing devices 102 of FIG. 1. At step 206, the service acquires operating environment data, such as resource availability data (either for service 110 of FIG. 1 or for the one or more computing devices 102 of FIG. 1). At step 208, the service analyses the operating environment data, and at step 210, determines the log data upload policy for the one or more computing devices 102 of FIG. 1. At step 212 the service transmits the log data upload policy to the one or more computing devices 102 of FIG. 1. The process then either loops back to acquire more up-to-date operating environment data at step 206 or ends at End step 214.

In FIG. 3 is shown an electronic system according to one implementation of the present technology within a logging arrangement like that shown in FIG. 1 and according to the method of FIG. 2. In FIG. 3 are shown a network service 300 operatively connected to network-connected computing device 302 and to I/O interface component 320. Network-connected computing device 302 comprises a device resource availability component, responsive to interrogation by network service 300 to report on its resource availability to data acquisition component 312 via communications component 318. Network service 300 is equipped with a service resource availability component 306, operable to provide service operating environment data to data acquisition component 312. Data acquisition component 312 is operable to pass the data to analysis component 308, which analyses the operating environment data from at least one of network service 300 and network-connected computing device 302 as input to policy generator 310. Policy generator 310 communicates the generated policy to network-connected computing device 302 to enable network-connected computing device 302 to select the time and means by which to transmit logs to network service 300. Optionally, data acquisition component 312 is further operable to cooperate with flow identifier generator 314 to generate flow identifiers to enable correlation of log records by log flow correlator 316 for output via communications component 318 to I/O interface component 320 as an aid to diagnostics. In one alternative, network-connected computing device 302 may itself comprise a flow identifier generator 314 to generate flow identifiers to transmit to network service 300.

A typical flow correlation activity occurs when a network-connected computing device shares workload, either with other network-connected computing devices or with one or more services. A Flow-ID is generated, for example when a new execution flow to be logged starts (e.g. when a device is powered-on, or when a new transaction begins). The Flow-ID is inserted in all log records at any of the devices that are participating in the logged execution flow. Then, when the logs for an execution flow need to be analysed, log records from the participating devices can be correlated by matching Flow-IDs belonging to the same flow. Once the log for the flow is reassembled from multiple log records, all having matching Flow-IDs, it can be used to analyse malfunctions, performance, reliability and various other analytical uses known in the art.

The present technology is thus operable to collect logs from computing devices according to a configuration policy sent to the devices from a service. The policy may be based on resource availability at one or more of the network-connected computing device, the service, and the communication channels. The policy assists the computing device in determining when to upload logs and on what kind of network connection type (e.g. Wi-Fi® or 3G). The policy may include, for example, a time of day (e.g. 2:00 AM), a range of permitted times, one or more excluded times, an interval (e.g. every 4 h), or a “piggyback” parameter (e.g. when other communication with the device occurs) to conserve resources, such as device battery and connectivity fees, or to avoid conflict with higher-priority or very resource-intensive workloads. Other resources, such as bandwidth of communications channels or memory and external storage space at either the service or the computing device, may also be taken into account in the creation of the policy. The technology may operate by interrogating devices to acquire up-to-date individual or generalizable information about their resources—for example, one device or all devices in class X may tend to be low on power at certain times of day, or network Y is busiest when the east coast of the USA wakes up and many of its inhabitants log-in to check emails, or device memory is more likely to be heavily used when a device is processing an end-of-day database reorganisation or downloading and installing new firmware—this applies both on the network-connected computing device and on the service. Further, diagnostic log receipt and analysis at a service must often be given a lower priority than normal user transaction workloads, and thus the service itself may be constrained. When the resource information is received, the service can analyse the accumulated data and create, for example, a device or device class policy that helps the device select a time or communications means to send log data to the service.

In one implementation, the device configuration may be performed by the network service or by other means, for example, by a system administrator or a device manufacturer at production time. Device configuration may incorporate, among other things, keys for log encryption into the network-connected computing device. Device configuration may further include parameters governing, for example, the log size permitted on the device and the compression means for the network-connected computing device to use to compress log data to further reduce the resource cost associated with its storage and transmission. Compression means may include, for example, true compression by such methods as Lempel-Ziv-Welch encoding, or may involve encoding by means of a fixed look-up table shared by the network-connected computing device and the service.

Device configuration may also include parameters governing a log filtering arrangement to allow the device to minimize storage, network bandwidth and battery consumption on the network-connected computing device where these resources are often extremely scarce. Such a log filter may include, for example, the component name and the logged event severity level, so that only a subset of relevant logs will be kept on the device or transmitted over the communications channel.

In a refinement, the service may be operable to accept an opt-in signal from the network-connected computing device to indicate acceptance of control in compliance with said policy data. The opt-in may be for all customer devices, a specified device, according to device ID or network address, or for a group of devices, according to device attributes, such as a firmware version or a class property configured on the device.

In implementations of the presently-described technique, at least one resource at the network-connected computing device or at the service may comprise, for example, memory or external storage space availability, power level (such as battery charge level), processor availability and communications capacity and availability. The service may be operable to send configuration data to cause the network-connected computing device to filter log data according to a log filter policy. Such a log filter policy may be based on, for example, the component name and the logged event severity level (e.g., critical, error, info, debug), so that only a subset of relevant logs will be kept on the device or transmitted over the communications channel.

In a refinement, the network-connected service may be arranged to generate at least one flow identifier to be associated with at least one execution flow of the network-connected computing device, the network-connected computing device and the service being operable to identify at least one subset of the log data by associating log records from the execution flow with the at least one flow identifier, to receive an upload of log data from the network-connected computing device and to correlate the log data according to the at least one flow identifier.

The network-connected service may be operable to accept an opt-in signal from the at least one network-connected computing device to indicate acceptance of control in compliance with said policy data.

The present technique may be implemented such that the network-connected service may comprises a virtual device, which may be, for example, a local partition of a multi-partition system, or which may be distributed for operation, for example, in a grid environment, a cloud environment, or any other distributed processing environment.

As will be appreciated by one skilled in the art, the present technique may be embodied as a system, method or computer program product. Accordingly, the present technique may take the form of an entirely hardware embodiment, an entirely software embodiment, or an embodiment combining software and hardware.

Furthermore, the present technique may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A machine-implemented method of operating a network-connected service comprising:
establishing communication with a network-connected computing device;
acquiring, by said network-connected service from said network-connected computing device at least one indication of availability to said network-connected computing device of at least one first resource;
acquiring, by said network-connected service at least one indication of availability to said network-connected service of at least one further resource;
analysing a plurality of said indications to determine at least one of a time and a communication configuration for transmission of log data from said network-connected computing device to said network-connected service, where said time and said communication configuration are determined by resource availability to at least one of said network-connected computing device and said network-connected service; and
sending, to said network-connected computing device, log transmission policy data to enable said network-connected computing device to select at least one of a transmission time and a communication configuration for transmission of said log data to said network-connected service in compliance with said policy data.

2. The machine-implemented method of claim 1, wherein said at least one said first resource comprises at least one of a memory space, a power level and a communications capacity.

3. The machine-implemented method of claim 1, wherein said at least one said second resource comprises at least one of a memory space, a power level and a communications capacity.

4. The machine-implemented method of claim 1, further comprising sending configuration data to cause said network-connected computing device to filter log data according to a log filter policy.

5. The machine-implemented method of claim 4, wherein said log filter policy comprises at least one of a component identifier and a severity indicator.

6. The machine-implemented method of claim 1, said network-connected service being further operable to:
generate at least one flow identifier to be associated with at least one execution flow of said network-connected computing device, said network-connected computing device being operable to identify at least one subset of said log data by associating log records from said execution flow with said at least one flow identifier;
receive an upload of said log data from said network-connected computing device; and
correlate said log data at said network-connected service according to said at least one flow identifier.

7. The machine-implemented method of claim 1, said network-connected service being further operable to accept an opt-in signal from said at least one said network-connected computing device to indicate acceptance of control in compliance with said policy data.

8. The machine-implemented method of claim 1, said network-connected service comprising a virtual device.

9. The machine-implemented method of claim 8, said network-connected service comprising a virtual device operable in at least one of a grid environment and a cloud environment.

10. An electronic control device comprising logic apparatus operable to:
establish communication between a network-connected service and a network-connected computing device;
acquire, by said network-connected service from said network-connected computing device at least one indication of availability to said network-connected computing device of at least one first resource;
acquire, by said network-connected service at least one indication of availability to said network-connected service of at least one further resource;
analyse a plurality of said indications to determine at least one of a time and a communication configuration for transmission of log data from said network-connected computing device to said network-connected service, where said time and said communication configuration are determined by resource availability to at least one of said network-connected computing device and said network-connected service; and
send, to said network-connected computing device, log transmission policy data to enable said network-connected computing device to select at least one of a transmission time and a communication configuration for transmission of said log data to said network-connected service in compliance with said policy data.

11. A computer program comprising computer program code to, when loaded into a computer system, cause said system to:
establish communication between a network-connected service and a network-connected computing device;
acquire, by said network-connected service from said network-connected computing device at least one indication of availability to said network-connected computing device of at least one first resource;
acquire, by said network-connected service at least one indication of availability to said network-connected service of at least one further resource;
analyse a plurality of said indications to determine at least one of a time and a communication configuration for transmission of log data from said network-connected computing device to said network-connected service, where said time and said communication configuration are determined by resource availability to at least one of said network-connected computing device and said network-connected service; and
send, to said network-connected computing device, log transmission policy data to enable said network-connected computing device to select at least one of a transmission time and a communication configuration for transmission of said log data to said network-connected service in compliance with said policy data.
